(19) United States
(12) Patent Application Publication
(10) Pub. No.: US 2017/0056912 A1
(43) Pub. Date: Mar. 2, 2017

(54) LIQUID PRECURSOR DELIVERY SYSTEM

(71) Applicant: KOREA INSTITUTE OF INDUSTRIAL TECHNOLOGY, Cheonan-si Chungcheongnam-do (KR)

(72) Inventors: Bum Ho CHOI, Gwangju (KR); Jong Ho LEE, Gwangju (KR)

(73) Assignee: KOREA INSTITUTE OF INDUSTRIAL TECHNOLOGY, Chungcheongnam-do (KR)

(21) Appl. No.: 14/760,227

(22) PCT Filed: Dec. 30, 2014
(86) PCT No.: PCT/KR2014/013035

§ 371 Date: Jul. 10, 2015

(30) Foreign Application Priority Data
May 9, 2014 (KR) 10-2014-0055770

(51) Int. Cl. B05B 17/06; B05B 9/00

(52) U.S. Cl. CPC B05B 17/06; B05B 9/002

(57) ABSTRACT

Disclosed is a liquid precursor delivery system that enables a thin film deposition process to be performed at a low temperature like 350° C. or lower in a process of manufacturing semiconductor devices or displays. The liquid precursor delivery system includes an aerosol generator, a vaporizer, and a vapor storage tank. The aerosol generator changes a liquid precursor into an aerosol precursor using ultrasonic vibrations. The vaporizer has a heater block in which a plurality of sloped plate-shaped heaters is arranged in a zigzag form and in which the aerosol precursor changes into a gas precursor by colliding with the heaters and thus obtaining heat energy. The vapor storage tank stores the gas precursor while maintaining a constant pressure and temperature of the gas precursor and delivers the gas precursor to a process chamber when a thin film deposition process is performed.

### TECHNICAL FIELD

The present invention relates to a liquid precursor delivery system and, more particularly, to a liquid precursor delivery system that enables a thin film deposition to be performed even at a low temperature in a process of manufacturing semiconductor devices or displays.

### BACKGROUND ART

In a process of manufacturing semiconductor devices or displays, a liquid precursor is typically used to deposit a thin film. The liquid precursor has a form in which a metal-organic ligand surrounds a material to be deposited on a target. To deposit a pure thin film, a process of decomposing the metal-organic ligand using heat or plasma is used.

For example, trimethyl-aluminum (TMA), which is the most frequently used material for deposition of alumina, has a structure in which three CH3 molecules surround one Al molecule. It is possible to separate the CH3 molecules from the Al molecule by using heat, plasma, or ozone.

A conventional liquid precursor delivery system delivers a liquid precursor to a process chamber in a manner of forming bubbles in a container (referred to as storage tank or canister) in which the liquid precursor is stored and then transferring the bubbles to the process chamber using a carrier gas.

However, the conventional liquid precursor delivery system has a problem that polymer remains on a deposited thin film when a heavy metal is deposited on a target because a liquid precursor that is continuously applied with heat for vaporization of the liquid precursor is deteriorated and thus the ligand cannot be completely decomposed.

In addition, when vaporizing the liquid precursor using a conventional bubble-producing method shown in FIG. 1, local cooling occurs due to vaporization heat needed when the liquid precursor is vaporized in a vaporizer, which causes the vaporized precursor to be re-liquefied. That is, the internal thermal capacity of the vaporizer cannot be fully used.

Meanwhile, a thin film deposition process is typically performed at a temperature of 550° C. or higher. Therefore, a heater for raising the temperature is necessarily used in the thin film deposition process, and a substrate that is unlikely to deform or is free from thermal stress at a temperature of 550° or higher is needed for the thin film deposition process. The use of heaters and special substrates is one of the causes of an increase in production cost for semiconductor devices or displays.

### DISCLOSURE

### Technical Problem

Accordingly, the present invention has been made keeping in mind the above problems occurring in the prior art, and an object of the present invention is to provide a liquid precursor delivery system that enables a thin film deposition process to be performed even at a temperature of 350° or lower.

In addition, another object of the present invention is to provide a liquid precursor delivery system that can reduce production cost for semiconductor devices or displays.

### Technical Solution

In order to accomplish the above objects, according to one aspect, there is provided a liquid precursor delivery system including: an aerosol generator that changes a liquid precursor into an aerosol precursor using ultrasonic vibrations; a vaporizer having a heater block in which a plurality of sloped plate-shaped heaters is arranged in a zigzag form and in which the aerosol precursor transferred from the aerosol generator changes into a gas precursor by colliding with the heaters and thus obtaining heat energy generated due to the collision; and a vapor storage tank that stores the gas precursor while maintaining a constant pressure and temperature of the gas precursor and delivers the gas precursor to a process chamber when a thin film deposition process is performed.

The aerosol generator may include: a storage tank in which the liquid precursor is stored; an ultrasonic vibrator that is installed under the storage tank and causes ultrasonic vibrations so that the liquid precursor in the storage tank is changed into the aerosol precursor; and a level sensor that protrudes inward from an inside surface of the storage tank and detects a level of a residual liquid precursor in the storage tank.

The heaters may be made of a nickel body containing tungsten.

The vaporizer may further include a temperature controller that makes the heater block maintain a constant temperature so that an instantaneous vaporization rate can be increased.

The temperature controller may adjust a temperature of the heater block so that the temperature can be maintained in a range from room temperature to 350° C., which is a vaporization temperature range of the liquid precursor.

The vaporizer can adjust a vaporization capacity according to kinds of the liquid precursor.

The vapor storage tank may have an automatic purging function that cleans an inside of the vapor storage tank using a gas purging method in a vacuum state in order to prevent the liquid precursor from remaining in the vapor storage tank during an idling period in which a thin film deposition process is not performed.

The liquid precursor delivery system may further include an isolation valve installed between the vaporizer and the vapor storage tank in order to stop the gas precursor from being continuously delivered to the vapor storage tank.

The isolation valve may be opened after the aerosol precursor is completely changed into the gas precursor.

The liquid precursor delivery system may further include: a canister in which the liquid precursor is stored; a liquid mass flow controller that is installed between the canister and the aerosol generator and that adjusts a flow rate of the liquid precursor delivered to the aerosol generator from the canister; a regulator that is installed between the canister and the liquid mass flow controller in order to adjust a pressure of the liquid precursor; a first adjustment valve installed between the canister and the regulator; a second adjustment valve installed between the canister and the liquid mass flow controller; and a third adjustment valve installed between the first adjustment valve and the second adjustment valve.

### Advantageous Effects

According to the present invention, first, a liquid precursor is delivered to a vaporizer in the form of aerosol and thus the aerosol precursor uniformly disperses in the vaporizer. Therefore, local cooling attributable to vaporization heat is prevented. Second, the aerosol precursor collides with heaters that have a sloped plate structure and are arranged in a zigzag form, thus changing the aerosol precursor into a gas precursor. Therefore, internal thermal capacity of the vaporizer can be fully used. This enables a thin film to be deposited even at a low temperature and also eliminates the need of a special substrate that is suitably used for a high temperature process, reducing production cost for semiconductor devices and displays.

### DESCRIPTION OF DRAWINGS

FIG. 1 is a diagram illustrating a method of vaporizing a liquid precursor using a conventional bubble-producing method;

FIG. 2 is a diagram illustrating a liquid precursor delivery system according to one embodiment of the invention;

FIG. 3 is a diagram illustrating an aerosol generator shown in FIG. 2;

FIG. 4a is a front view illustrating a heater block installed in a vaporizer shown in FIG. 2;

FIG. 4b is a side view illustrating the heater block in the vaporizer shown in FIG. 2; and

FIG. 5 is a diagram illustrating a vapor storage tank that stores a precursor shown in FIG. 2.

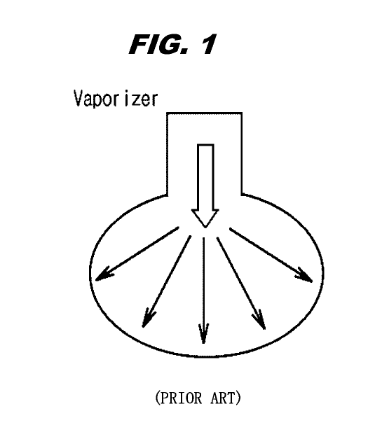

### BEST MODE

Hereinafter, preferred embodiments of the present invention will be described in detail with reference to the accompanying drawings so that those skilled in the art can easily implement the present invention. In the following description of operational principles of embodiments of the present invention, detailed descriptions of known functions and components incorporated herein will be omitted when it may make the subject matter of the present invention unclear.

In addition, the same reference numerals will refer to the same or like parts.

It will be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present. Other expressions that explain the relationship between elements, such as “between,” “directly between,” “adjacent to,” or “directly adjacent to,” should be construed in the same way.

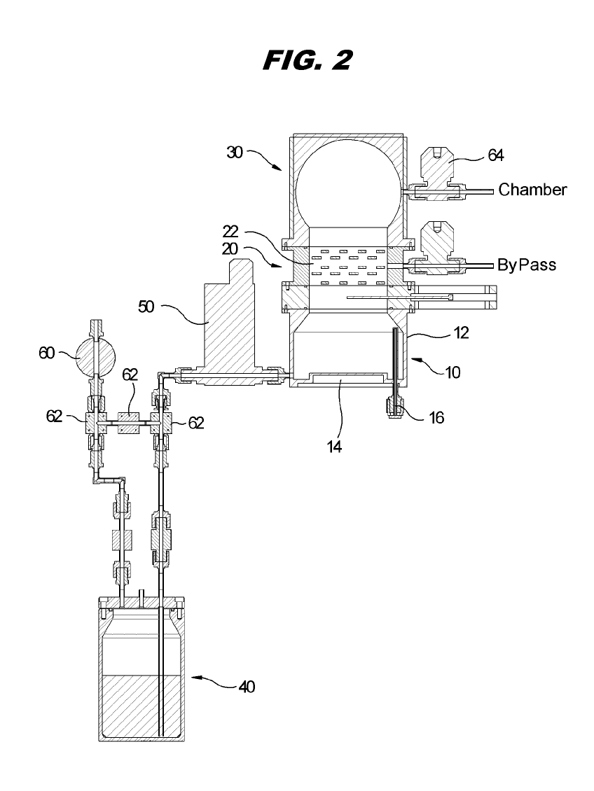

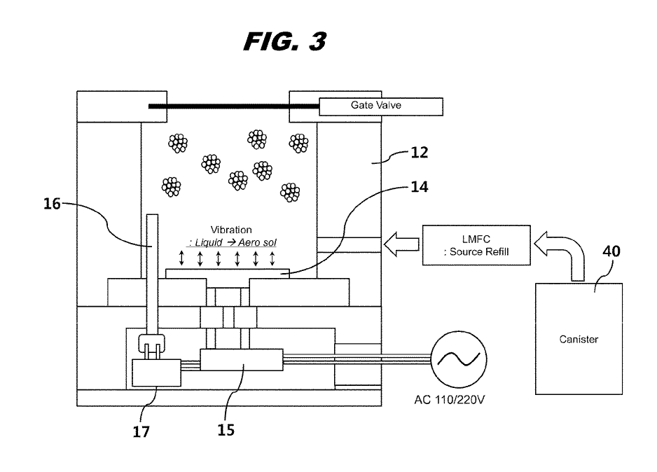

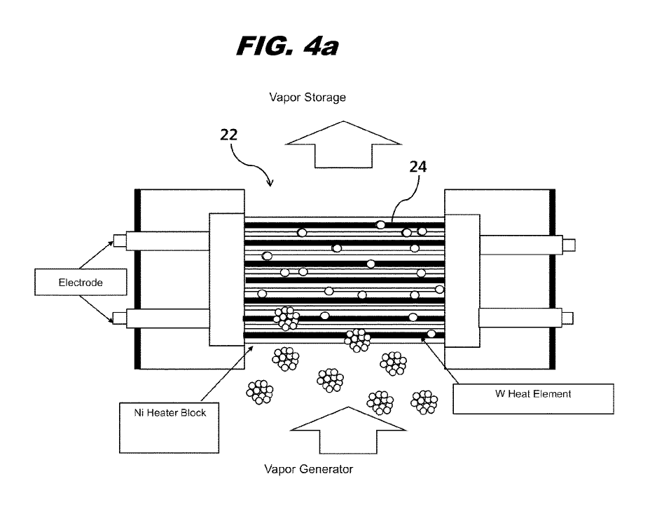

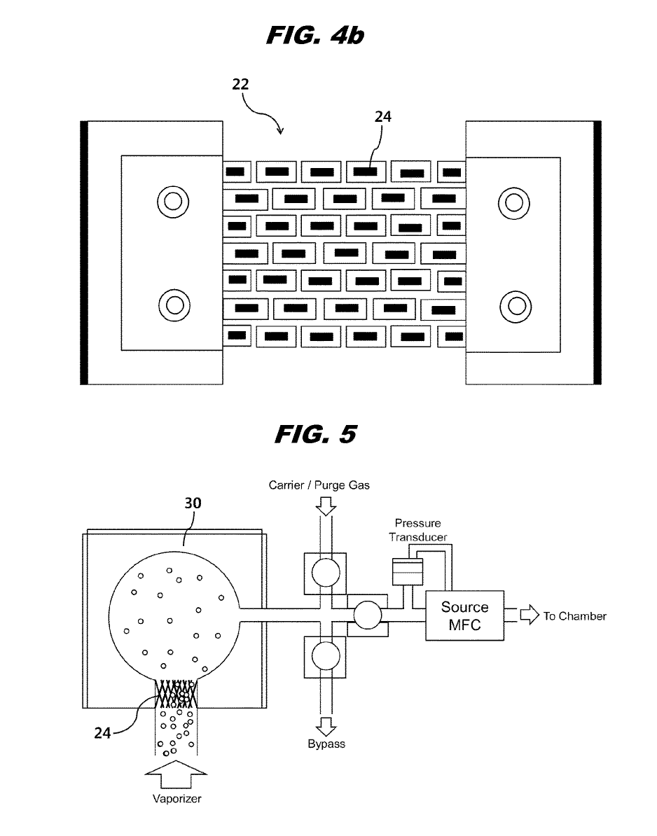

FIG. 2 is a diagram illustrating a liquid precursor delivery system according to one embodiment of the invention; FIG. 3 is a diagram illustrating an aerosol generator shown in FIG. 2; FIG. 4a is a front view illustrating a heater block installed in a vaporizer shown in FIG. 2; FIG. 4b is a side view illustrating the heater block in the vaporizer shown in FIG. 2; and FIG. 5 is a diagram illustrating a vapor storage tank that stores a precursor shown in FIG. 2.

With reference to FIGS. 2 through 5, a liquid precursor delivery system according to one embodiment of the present invention includes an aerosol generator 10, a vaporizer 20, and a vapor storage tank 30.

The aerosol generator 10 converts a liquid precursor stored therein into an aerosol precursor using a piezo-type ultrasonic vibrator 14. The aerosol generator 10 includes a storage tank 12 in which the liquid precursor is stored, the ultrasonic vibrator 14 that is installed under the storage tank 12 and causes ultrasonic vibrations, which are transferred to the storage tank, to change the liquid precursor in the storage tank 12 into the aerosol precursor, and a level sensor 16 or a weight sensor that protrudes inward from the inside surface of the storage tank 12 and detects a level of a residual liquid precursor.

The ultrasonic vibrator 13 causes ultrasonic vibrations when an ultrasonic oscillator-and-rectifier circuit 15 is powered as shown in FIG. 13. The level sensor 16 detects the level of the residual liquid precursor in the storage tank 12 when power is supplied to its power supply or a rectifier circuit 17.

The purpose of changing the liquid precursor into the aerosol precursor using the aerosol generator 10 is to make the most of thermal capacity of the vibrator 12 that is installed at a next stage of the aero generator 10. That is, since the aerosol precursor in a semi-gaseous state can uniformly disperse in the vibrator when it is fed into the vibrator, local cooling attributable to vaporization heat that is typically needed in the conventional bubble-producing method can be prevented.

The vaporizer 20 is a device that changes the aerosol precursor transferred from the aerosol generator 10 into a gas precursor. The vaporizer 20 has a heater block 22 in which a plurality of heaters 24 having a sloped plate shape is arranged in a zigzag form as shown in FIGS. 4a and 4b in order to make the most of the heat in the vaporizer 20. The aerosol precursor that is fed into the heater block 22 collides with the heater block 22 and thus obtains energy due to the collision, thereby changing into a gas precursor. The heaters 24 of the heater block 22 may be made of any metal as long as the metal can be heated to 350° C. or higher. However, it is preferable that the heaters 24 may be made of a nickel body containing tungsten.

In order to increase an instantaneous vaporization rate, the vaporizer 20 may be equipped with a temperature controller (not shown) that enables the heaters 24 of the heater block 20 to maintain a constant temperature. In this case, the temperature controller can adjust the temperature range of the vaporizer 20 such that the temperature of the vaporizer 20 can reach the temperature of the heater block 22 so that the vaporizer 20 can be used to gasify various kinds of liquid precursors. Preferably, the temperature controller can adjust the temperature of the heater block 22 such that the vaporizer 20 is suitably used to gasify the liquid precursor having a vaporization temperature range of 350° C. at the room temperature.

The vaporizer 20 has a maximum vaporization capacity of 0.3 g/cm³. However, the vaporization capacity can be adjusted according to kinds of liquid precursors.

The vapor storage tank 30 is a vessel to store a precursor that is vaporized by the vaporizer 20 at a constant pressure and temperature. The vapor storage tank 30 has a spherical shape that is advantageous in preserving the thermal capacity to maintain a constant pressure (i.e. constant saturation vapor pressure).

To this end, the vapor storage tank 30 preferably includes a pressure gauge that measures the internal pressure of the vapor storage tank 30 and a pressure regulator that adjusts the internal pressure of the vapor storage tank 30. The vapor storage tank 30 may further include a temperature sensor that measures the internal temperature of the vapor storage tank 30 and a temperature regulator (for example, heater) that adjusts the internal temperature of the vapor storage tank 30.

The vapor storage tank 30 may have an automatic purging function that cleans the inside of the vapor storage tank 30 in a vacuum state using a gas purging method in order to prevent the residual liquid precursor from remaining in the vapor storage tank 30.

As shown in FIG. 5, the vapor storage tank 30 is connected to a carrier-and-purge gas supply pipe through which a carrier-and-purge gas is supplied and a bypass pipe through which the carrier-and-purge gas used in the cleaning process is discharged. The carrier-and-purge gas supply pipe, the bypass pipe, and a discharge pipe are equipped with respective valves.

The automatic purging function is not performed during a deposition period in which the thin film deposition process is performed but be performed only during an idling period in which the thin film deposition process is not performed. The time for performing the automatic purging is about 20 seconds or shorter, thereby not influencing the thin film deposition process. The automatic purging function is controlled by a controller (not shown). The controller preferably controls the functions of the temperature controller, the pressure regulator, and the temperature regulator as well as controls the automatic purging function.

The liquid precursor delivery system according to the present invention further includes a canister 40 in which a liquid precursor is stored, a liquid mass flow controller (hereinafter abbreviated to LMFC or LFC) 50 that is installed between the canister 40 and the aerosol generator 10 and that adjusts the flow rate of the liquid precursor delivered to the aerosol generator 10, a regulator 60 that is installed between the canister 40 and the LMFC 50 and adjusts the pressure of the liquid precursor, and a plurality of adjustment valves 62 each of which is installed between the canister 40 and the regulator 60 or the canister 40 and the LMFC 50. The liquid precursor delivery system according to the embodiment described above operates in the following manner.

First, the controller performs control of opening a first adjustment valve installed between the canister 40 and the regulator 60 to allow the liquid precursor stored in the canister 40 to be delivered to the aerosol generator 10, a second adjustment valve installed between the canister 40 and the LMFC 50, and a third adjustment valve installed between the first adjustment valve and the second adjustment valve. The adjustment valves 62 are preferably opened by the controller or may be manually opened by an operator.

In the state in which the adjustment valves 62 are opened, the controller controls operation of the regulator 60 to adjust the pressure of the liquid precursor that is transferred to the aerosol generator 10 from the canister 40, and controls operation of the LMFC 50 to adjust the flow rate of the liquid precursor that is transferred to the aerosol generator 10 from the canister 40.

When the liquid precursor is delivered to the aerosol generator 10, the controller operates the ultrasonic vibrator so that the liquid precursor stored in the aerosol generator can change into an aerosol precursor by ultrasonic vibrations. In this case, the level sensor 16 detects the level of the residual liquid precursor and sends the information of the level to the controller. The controller controls the adjustment valves 62, the regulator 60, and the LMFC 60 according to a detection signal that represents the level of the residual liquid precursor that is sent from the level sensor 16, so that a suitable level of the residual liquid precursor can be maintained in the aerosol generator 10, in which the suitable level means the level of the liquid precursor that is necessary for deposition of a thin film.

The controller may also calculate a production amount of aerosol per hour based on the information of the level of the residual liquid precursor that is sent from the level sensor 16 and provide an operator with the calculated value.

The aerosol precursor that is generated by the aerosol generator 10 is transferred to the vaporizer 20, and the aerosol precursor that is transferred to the vaporizer 20 collides with the heater block 22 having a sloped plate structure installed in the vaporizer 20. The aerosol precursor obtains heat energy generated due to the collision and thus changes into a gas precursor. The heater block 22 is controlled by the temperature controller such that a constant temperature can be maintained.

When the aerosol precursor is changed into a gas by the vaporizer 20, the controller opens an isolation valve (also, referred to as shut-off valve, not shown) installed between the vaporizer 20 and the vapor storage tank 30 so that the gas precursor can be transferred to and stored in the vapor storage tank 30. The isolation valve is a device to prevent the gas precursor from being continuously delivered to the vapor storage tank 30 from the vaporizer 20. The isolation valve is closed until the aerosol precursor completely changes into a gas and then switches open after the aerosol precursor completely changes into a gas precursor.

The present invention prevents the gas precursor from undergoing a phase change to a liquid state. In a conventional bubble-producing liquid precursor delivery system, local cooling occurs due to vaporization heat when a liquid precursor moves to a vaporizer through a direct spraying method right after the liquid precursor is heated. Therefore, a gas precursor is likely to undergo a phase change to a liquid state. However, according to the present invention, since only a gas precursor that is completely gasified by sufficient vaporization heat in the vaporizer 20 is delivered to the vapor storage tank 30, the gas precursor is unlikely to change back into the liquid precursor.

The controller performs an automatic purging function to clean the inside of the vapor storage tank 30 before the gas precursor is delivered to the vapor storage tank 30. That is, the controller prevents the liquid precursor from being present in the vapor storage tank 30. In this case, the automatic purging function is performed for about 20 seconds or shorter during an idling period in which a thin film deposition process is not performed so that the thin film deposition process is not interrupted.

When the gas precursor is stored in the vapor storage tank 30, the pressure gauge measures the pressure in the vapor storage tank 30. The measured pressure information is sent to the controller. Then, the controller controls the pressure regulator such that an adequate pressure of the precursor can be maintained in the vapor storage tank 30. The controller receives the information of the internal temperature of the vapor storage tank 30 from the temperature sensor and controls the temperature regulator such that an adequate internal temperature of the vapor storage tank 30 can be maintained by the temperature regulator.

During the thin film deposition, the controller performs control of opening a delivery valve between the vapor storage tank 30 and the chamber such that the gas precursor in the vapor storage tank 30 can be delivered to a process chamber. The controller makes the delivery valve 64 closed during the idling period in which the thin film deposition process is not performed.

According to the liquid precursor delivery system according to the embodiment of the present invention, since a liquid precursor is changed into an aerosol precursor before it is delivered to the vaporizer 20 (i.e., the precursor is delivered to the vaporizer 20 in the form of aerosol), the precursor uniformly disperses in the vaporizer 20. Therefore, local cooling attributable to vaporization heat is prevented. In addition, since the aerosol precursor is vaporized by colliding with the heaters 24 that have a sloped plate shape and are arranged in a zigzag pattern, it is possible to make the most of the internal thermal capacity of the vaporizer 20, enabling a thin film deposition process to be performed at a low temperature. Furthermore, since it is not necessary to use a special substrate that is suitably used under a high temperature condition, production cost for semiconductor devices and displays can be reduced.

Although the present invention has been described in detail with reference to specific embodiments, those embodiments are provided only for illustrative purposes. Therefore, those embodiments are not intended to limit the scope of the present invention, but rather those skilled in the art will appreciate that various modifications, additions and substitutions are possible, without departing from the scope and spirit of the invention as disclosed in the accompanying claims. Further, simple changes and modifications of the present invention are appreciated as included in the scope and spirit of the invention, and the protection scope of the present invention will be defined by the accompanying claims.

### DESCRIPTION OF THE REFERENCE NUMERALS IN THE DRAWINGS

10: aerosol generator
12: storage tank
14: ultrasonic vibrator
16: level sensor
20: vaporizer
22: heater block
24: heater
30: vapor storage tank
40: canister
50: liquid mass flow controller (LMFC)
60: regulator
62: adjustment valve
64: delivery valve

1. A liquid precursor delivery system, comprising:
an aerosol generator that changes a liquid precursor into an aerosol precursor using ultrasonic vibrations;
a vaporizer having a heater block in which a plurality of sloped plate-shaped heaters is arranged in a zigzag form and in which the aerosol precursor transferred from the aerosol generator changes into a gas precursor by colliding with the heaters and thus obtaining heat energy generated due to the collision; and
a vapor storage tank that stores the gas precursor while maintaining a constant pressure and temperature of the gas precursor and delivers the gas precursor to a chamber when a thin film deposition process is performed.

2. The liquid precursor delivery system according to claim 1, wherein the aerosol generator includes:
a storage tank in which the liquid precursor is stored;
an ultrasonic vibrator that is installed under the storage tank and causes ultrasonic vibrations so that the liquid precursor in the storage tank is changed into the aerosol precursor; and
a level sensor that protrudes inward from an inside surface of the storage tank and detects a level of a residual liquid precursor in the storage tank.

3. The liquid precursor delivery system according to claim 1, wherein the heaters are made of a nickel body containing tungsten.

4. The liquid precursor delivery system according to claim 1, wherein the vaporizer further includes a temperature controller that makes the heater block maintain a constant temperature to increase an instantaneous vaporization rate.

5. The liquid precursor delivery system according to claim 4, wherein the temperature controller adjusts a temperature of the heater block so that the temperature is in a range from room temperature to 350° C., which is the liquid precursor's a vaporization temperature range.

6. The liquid precursor delivery system according to claim 1, wherein the vaporizer can adjust a vaporization capacity according to kinds of the liquid precursor.

7. The liquid precursor delivery system according to claim 1, wherein the vapor storage tank has an automatic purging function that cleans an inside of the vapor storage tank using a gas purging method in a vacuum state in order to prevent the liquid precursor from being present in the vapor storage tank during an idling period in which a thin film deposition process is not performed.

8. The liquid precursor delivery system according to claim 1, further comprising an isolation valve provided between the vaporizer and the vapor storage tank in order to stop the gas precursor from being continuously delivered to the vapor storage tank.

9. The liquid precursor delivery system according to claim 8, wherein the isolation valve is opened after the aerosol precursor is completely changed into the gas precursor.

10. The liquid precursor delivery system according to claim 1, further comprising:
a canister in which the liquid precursor is stored;
a liquid mass flow controller that is installed between the canister and the aerosol generator and that adjusts a flow rate of the liquid precursor delivered to the aerosol generator from the canister;
a regulator that is installed between the canister and the liquid mass flow controller in order to adjust a pressure of the liquid precursor;
a first adjustment valve installed between the canister and the regulator;
a second adjustment valve installed between the canister and the liquid mass flow controller; and
a third adjustment valve installed between the first adjustment valve and the second adjustment valve.
